(19) United States
(12) Patent Application Publication
(10) Pub. No.: US 2026/0171072 A1
(43) Pub. Date: Jun. 18, 2026

(54) Real-Time Generation of Natural-Sounding Audio Content from Context Data

(71) Applicant: Google LLC, Mountain View, CA (US)

(72) Inventors: Usama Bin Shafqat, New York, NY (US); Manika Puri, Mountain View, CA (US); Simon Tokumine, London (GB); Trond Thomas Wuellner, Mountain View, CA (US); David Charles Black, Mountain View, CA (US); Janakitti Ratana-Rueangsri, Mountain View, CA (US); Arielle Teryn Fox, Oakland, CA (US); Yi Li, Cupertino, CA (US); Tzu-Yin Chen, Brooklyn, NY (US); Nadia Maria Ciobanu, Mountain View, CA (US); Christopher Lee Gammage, Hayward, CA (US); Nikhil Sarda, San Francisco, CA (US)

(21) Appl. No.: 19/420,468

(22) Filed: Dec. 15, 2025

Related U.S. Application Data
(60) Provisional application No. 63/733,896, filed on Dec. 13, 2024.

(51) Int. Cl. G10L 13/047; G10L 15/18

(52) U.S. Cl. CPC G10L 13/047; G10L 15/1815

(57) ABSTRACT

Provided are computer systems and methods for automatic generation of natural-sounding audio content from a variety of input data. The proposed systems and methods address several technical challenges observed in previous attempts to apply machine learning to this task. In particular, when applied to task of automatic audio content generation, traditional large models such as large language models (LLMs) or similar often produced audio content that sounded unnatural due to issues such as preachy tones, excessive flattery, awkward transitions, monotone delivery, and/or limited conversation length. These drawbacks made the generated dialogues feel less engaging and realistic.

### RELATED APPLICATIONS

This application claims priority to and the benefit of U.S. Provisional Patent Application No. 63/733,896, filed Dec. 13, 2024, and titled “Real-Time Generation of Natural-Sounding Audio Content From Context Data”. U.S. Provisional Patent Application No. 63/733,896 is hereby incorporated by reference in its entirety.

### FIELD

The present disclosure relates generally to machine learning processes and machine-learned devices and systems. More particularly, the present disclosure relates to systems and methods for processing large and diverse datasets to produce natural-sounding and contextually relevant audio outputs.

### BACKGROUND

In the field of automated audio content generation, a significant technical challenge has been the efficient and accurate processing of large and diverse datasets to produce natural-sounding and contextually relevant audio outputs. Traditional systems often struggle to handle the computational demands associated with processing extensive textual and multimodal data, such as videos, which can lead to delays, errors, and inefficiencies in content generation. Additionally, these systems frequently lack the capability to dynamically interact with users in real-time. Another technical hurdle is that existing methods often produce outputs that are either prone to errors or lack the subtleties of human speech, detracting from the user's experience and the utility of the content.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a computer-implemented method for automatic generation of audio content. The computer-implemented method includes obtaining, by a computing system which may include one or more computing devices, a corpus of context data. The method also includes processing, by the computing system, the context data with a one or more machine-learned sequence processing models to generate, as output of the one or more machine-learned sequence processing models, a transcript for audio content, where the transcript may include description of one or more topics contained within the context data. The method also includes generating, by the computing system, audio content from the transcript, where the audio content may include speech content that verbalizes the transcript. The method also includes providing, by the computing system, the audio content for playback. Other embodiments of this aspect include corresponding computer systems, apparatus, and computer programs recorded on one or more computer storage devices, each configured to perform the actions of the methods.

Example implementations may include any combination of one or more of the following features. The computer-implemented method may include: receiving, by the computing system, interaction data, where the interaction data may include an additional conditioning input; processing, by the computing system, the additional conditioning input and at least a portion of the transcript with the one or more machine-learned sequence processing models to generate, as output of the one or more machine-learned sequence processing models, an updated transcript; generating, by the computing system, updated audio content from the updated transcript; and providing, by the computing system, the updated audio content for playback. Receiving the interaction data may include receiving the interaction data during playback of the audio content, and where the method may include pausing playback of the audio content during generation of the updated audio content. The portion of the transcript may include a remaining portion of the transcript that temporally follows an interaction time associated with the injection data. The additional conditioning input may include: an interjection, a clarification request, an on-topic question, a focus steering input, an exclusion steering input, a target audience steering input, a host persona steering input, or a tone or format steering input. The interaction data may include user speech data captured by a microphone. Providing the audio content for playback may include streaming the audio content via a real-time communication (RTC) framework. Processing, by the computing system, the context data with the one or more machine-learned sequence processing models to generate the transcript may include: dividing, by the computing system, the context data into a plurality of chunks; respectively processing, by the computing system, the plurality of chunks individually with the one or more machine-learned sequence processing models to respectively generate a plurality of reduced-data-size content chunks; and processing, by the computing system, the plurality of reduced-data-size content chunks with the one or more machine-learned sequence processing models to generate the transcript. Processing, by the computing system, the context data with the one or more machine-learned sequence processing models to generate the transcript may include: prior to processing the context data to generate the transcript, transforming, by the computing system, at least one video contained in the context data into a textual format. Processing, by the computing system, the context data with the one or more machine-learned sequence processing models to generate the transcript may include hierarchically generating the transcript. Hierarchically generating the transcript may include: processing, by the computing system, the context data with the one or more machine-learned sequence processing models to generate, as output of the one or more machine-learned sequence processing models, an outline for the audio content, where the outline may include a plurality of sections; and iteratively processing, by the computing system, the context data with the one or more machine-learned sequence processing models to iteratively generate, as output of the one or more machine-learned sequence processing models, a portion of the transcript for each of the plurality of sections. Processing, by the computing system, the context data with the one or more machine-learned sequence processing models to generate the transcript may include: processing, by the computing system, the context data with the one or more machine-learned sequence processing models to generate, as output of the one or more machine-learned sequence processing models, an initial transcript for the audio content; and performing, by the computing system, one or more critic-driven re-write loops to edit the initial transcript to generate an edited transcript. Performing, by the computing system, the one or more critic-driven re-write loops may include rewriting, by the computing system, the initial transcript to include an increased amount of disfluencies. Performing, by the computing system, the one or more critic-driven re-write loops may include processing, by the computing system, the context data and the initial transcript with the one or more machine-learned sequence processing models to generate, as output of the one or more machine-learned sequence processing models, the edited transcript, where the edited transcript exhibits increased grounding relative to the context data. Performing, by the computing system, the one or more critic-driven re-write loops may include: generating, by the computing system, initial audio content from the initial transcript; and processing, by the computing system, the initial audio content with the one or more machine-learned sequence processing models to identify one or more verbalization errors; and re-writing, by the computing system, the initial transcript to remove or replace portions of the transcript corresponding to the one or more verbalization errors. Performing, by the computing system, the one or more critic-driven re-write loops may include processing, by the computing system, the initial transcript and an audience persona description with the one or more machine-learned sequence processing models to generate, as output of the one or more machine-learned sequence processing models, the edited transcript, where the edited transcript is conditioned on and personalized toward an audience persona contained in the audience persona description. Generating, by the computing system, the audio content from the transcript may include processing, by the computing system, the transcript with a machine-learned voice model to generate the audio content as an output of the machine-learned voice model. The computer-implemented method may include generating, by the computing system, video content that is temporally or semantically synchronized with the audio content. The user interface may include one or more attribution or citation elements that provide attribution or citation information relative to the context data during playback of the audio content, where the one or more attribution or citation elements are temporally synchronized with the playback of the audio content. The audio content may include a dialog, a podcast, educational content, sports commentary, news commentary, or a summary of recent events.

A computer system can be configured to perform any of the methods described herein. One or more non-transitory computer-readable media can store computer-executable instructions for performing any of the methods described herein. Implementations of the described techniques may include hardware, a method or process, or computer software on a computer-accessible medium.

### BRIEF DESCRIPTION OF THE DRAWINGS

FIG. 1 depicts a graphical diagram of an example audio generation system according to example implementations of aspects of the present disclosure;

FIG. 2 depicts a graphical diagram of an example hierarchical encoding scheme within an example transcript generation/editing system of the audio generation system according to example implementations of aspects of the present disclosure;

FIG. 3 depicts a graphical diagram of an example hierarchical transcript generation process within an example transcript generation/editing system according to example implementations of aspects of the present disclosure;

FIG. 4 depicts a graphical diagram of an example critic-driven feedback loop within an example transcript generation/editing system according to example implementations of aspects of the present disclosure;

FIG. 5 depicts a graphical diagram of an example user interface that enables a user to interact with an example audio generation system according to example implementations of aspects of the present disclosure;

FIG. 6A depicts a graphical diagram of the paused state of an example audio playback interface according to example implementations of aspects of the present disclosure;

FIG. 6B depicts a graphical diagram of the playing state of an example audio playback interface according to example implementations of aspects of the present disclosure;

FIG. 6C depicts a graphical diagram of a user interacting via voice with an example audio playback interface according to example implementations of aspects of the present disclosure;

FIG. 7 is a flow chart diagram illustrating an example method for training a machine-learned model according to example implementations of aspects of the present disclosure;

FIG. 8 is a block diagram of an example processing flow for using machine-learned model(s) to process input(s) to generate output(s) according to example implementations of aspects of the present disclosure;

FIG. 9 is a block diagram of an example sequence processing model according to example implementations of aspects of the present disclosure;

FIG. 10 is a block diagram of an example technique for populating an example input sequence for processing by a sequence processing model according to example implementations of aspects of the present disclosure;

FIG. 11 is a block diagram of an example model development platform according to example implementations of aspects of the present disclosure;

FIG. 12 is a block diagram of an example training workflow for training a machine-learned model according to example implementations of aspects of the present disclosure;

FIG. 13 is a block diagram of an inference system for operating one or more machine-learned model(s) to perform inference according to example implementations of aspects of the present disclosure;

FIG. 14 is a block diagram of an example networked computing system according to example implementations of aspects of the present disclosure;

FIG. 15 is a block diagram of an example computing device according to example implementations of aspects of the present disclosure; and

FIG. 16 is a block diagram of an example computing device according to example implementations of aspects of the present disclosure.

### DETAILED DESCRIPTION

Example aspects of the present disclosure are directed to computer systems and methods for automatic generation of natural-sounding audio content from a variety of input data. The proposed systems and methods address several technical challenges observed in previous attempts to apply machine learning to this task. In particular, when applied to task of automatic audio content generation, traditional large models such as large language models (LLMs) or similar often produced audio content that sounded unnatural due to issues such as preachy tones, excessive flattery, awkward transitions, monotone delivery, and/or limited conversation length. These drawbacks made the generated dialogues feel less engaging and realistic.

In contrast, the proposed technology generates audio content that sounds more natural and engaging. This can be achieved through a series of processes that include obtaining and processing large sets of context data, generating transcripts, and converting these transcripts into audio formats that users can listen to. For instance, the system can handle inputs ranging from text to multimodal data, such as videos, which are then converted into a textual format for further processing. Specifically, one aspect of the present disclosure relates to the generation of long-form content by creating structured outlines and detailed sections through hierarchical processing. Another aspect of the present disclosure improves user interaction with the generated audio content by incorporating real-time feedback mechanisms. Users can influence the content dynamically during playback through commands or questions, which the system processes to update the audio content accordingly. This real-time adaptability enhances user experience by making audio content more responsive and personalized.

Thus, example aspects of the present disclosure advance the field of automated audio content generation by introducing methods that produce more natural, engaging, and interactive audio experiences. This technology can be particularly advantageous in applications such as virtual learning environments, interactive podcasts, and automated news reporting, where the quality of audio content significantly impacts user engagement and information retention.

More particularly, an example computing system for generating audio content can first obtain a large corpus of context data. In some implementations, the context data can encompass a wide variety of types, forms, or sources of content, which may include textual documents, audio files, videos, and/or live feeds from different domains such as news, academia, or entertainment. This data can be automatically selected and/or can be curated by a human user to focus on specific topics of interest. To provide an example, a user might compile a selection of scholarly articles, expert lectures, and recent news clips all pertaining to quantum computing to serve as the input for generating contextually-relevant audio content (e.g., a podcast or tutorial relating to quantum computing). This allows users to tailor the computing system to produce customized content that meets their specific informational needs or preferences (or those of their intended audience, which may differ from the specific user controlling the system).

Next, the computing system can process the context data using one or more machine-learned sequence processing models to generate a transcript for the intended audio content. This transcript can include descriptions of various topics extracted from the context data. The use of machine-learned models allows for the accurate identification and extraction of relevant topics from a wide array of data types, including textual and multimodal inputs. For instance, in the context of generating a podcast episode from a collection of academic works about quantum computing, the system can effectively discern and summarize key topics from the articles to be included in the transcript.

The computing system can then generate audio content from the prepared transcript, wherein the audio content comprises speech that verbalizes the transcript effectively. This step can include transforming the textual representations of the transcript into spoken words using advanced voice synthesis technologies. As one example, the system can utilize machine-learned voice models that are capable of producing natural-sounding speech, closely mimicking human intonation and pronunciation.

Once the audio content has been generated, the computing system can provide the audio content for playback to a user. For example, the system can stream the audio content directly to the user's device or make it available for download, depending on the user's preference and the application's design. The system can also support multiple formats of audio files, making it compatible with a wide range of devices and media players.

In some implementations, the computing system can provide the generated audio content for playback through streaming via a real-time communication (RTC) framework (e.g., WebRTC). This method allows the audio content to be streamed directly to users in real-time, facilitating immediate and seamless delivery of content as it is generated or updated. For example, in a live interactive podcast or a real-time educational webinar, the audio content can be streamed to listeners across different geographical locations without significant delays. This can increase the likelihood that all participants receive the content simultaneously and can interact with it in a timely manner. This feature is particularly advantageous in scenarios where immediate user interaction are desired, such as in live news broadcasting or during interactive learning sessions.

In some implementations, the corpus of content data may be a set of user-specific data that has been curated by the personalized content curation service. For example, a personalized content curation service can offer a dynamic and tailored experience by delivering a daily feed of articles, news stories, and other relevant content based on individual user preferences and interests. By analyzing user data with the user's consent, this service is able to curate a corpus of data that is highly customized and constantly updated to ensure that users receive the most pertinent and engaging information. This approach to content delivery helps users stay informed and connected with topics that matter most to them, enhancing their overall online experience.

According to one aspect of the present disclosure, the proposed systems can enable the user to pause and interact with the audio content during playback of the audio content. For example, in some implementations, the computing system can receive interaction data from the user (e.g., during playback of the original audio content). The interaction data can include additional conditioning inputs, with examples described in further detail below. This interaction data can be processed alongside at least a portion of the previously-generated transcript using one or more machine-learned sequence processing models. For instance, if a user requests clarification on a specific topic mentioned in the audio content, the system can receive this request as interaction data and use it to revise the relevant section of the transcript. The updated transcript is then used to generate new audio content that reflects the user's input. This updated audio content can be provided for playback. This feature can be particularly advantageous in educational settings where learners might need additional explanations or in interactive storytelling applications where listeners might want to explore different plot directions based on their choices.

In some implementations, the computing system can receive interaction data from the user during the playback of the audio content. For example, a user might provide feedback or ask a question while listening to a podcast or lecture. Upon receiving such interaction data, the system can pause the ongoing playback of the audio content. This pause allows the system to process the received interaction data and update the transcript accordingly, thereby generating new audio content that addresses the user's input. Once the updated audio content is ready, playback can resume, possibly starting from the point of interruption or from a new relevant section, thus providing a seamless and interactive listening experience.

In some implementations, the computing system can specifically process the portion of the transcript that temporally follows the interaction time associated with the received interaction data. For instance, if a user provides feedback or asks a question at a specific time during the audio playback, the system can identify this interaction time and focus on updating the subsequent sections of the transcript that come after this point. This approach increases the likelihood that the updates are relevant and timely. This can enhance the user's experience by directly addressing their immediate concerns or interests in the ongoing content.

In some implementations, the computing system can handle a variety of additional conditioning inputs received from users to revise the audio content. These inputs can include interjections, clarification requests, on-topic questions, as well as inputs steering the focus, exclusion of topics, target audience level, host persona, or the tone and format of the show. For example, if a user inputs a focus steering request such as “Talk more about Josephson junctions”, the system can adjust the remaining part of the transcript to concentrate specifically on that topic. Similarly, if a user requests a change in the tone of the show to resemble a short, engaging presentation rather than an academic lecture, the system can modify the delivery style of the content while keeping the core information the same. Each type of conditioning input can lead to modifications in the length and/or content of the transcript. This adaptive feature allows for a dynamic and interactive audio experience, allowing the user to interactively control the tone, substance, and/or style of the audio content.

In some implementations, the computing system can capture interaction data through user speech data obtained via a microphone. For instance, while listening to an audio presentation, a user might have questions or comments and can express these verbally. The system can then capture this spoken input directly through the microphone, process it to understand the user's intent, and use this information to modify the ongoing audio content accordingly. This feature allows for a hands-free interaction experience where users can engage with the content more naturally and conveniently. This can enhance accessibility and user-friendliness. Such a capability can be particularly advantageous in scenarios where users are multitasking or when the technology is being used in environments like vehicles or while exercising, where manual text input is impractical.

Another aspect of the present disclosure is directed to techniques for handling sets of content data that have large or “massive” size. As one example, in some implementations, the computing system can process large volumes of context data by first dividing the context data into a plurality of chunks. Each chunk is then individually processed by one or more machine-learned sequence processing models to generate reduced-data-size content chunks. For example, a document or a long video can be segmented into smaller, manageable parts, each part focusing on specific sections or topics. These smaller chunks are easier to handle and analyze. This can enhance the efficiency and accuracy of data processing. Subsequently, these reduced-data-size content chunks are further processed collectively to generate a transcript. This method increases the likelihood that the final transcript is a coherent and accurate representation of the original context data, facilitating the generation of detailed and precise audio content. This approach is particularly advantageous in scenarios including complex and voluminous data sets, such as multi-modal data, extensive technical documents, and/or long-form textual content such as novels or textbooks.

In some implementations, the generation of the transcript can include a step where at least one video contained in the context data is first transformed into a textual format before further processing to generate the transcript. For example, a video of a lecture or a news broadcast can be converted into text using advanced speech recognition technologies that accurately transcribe spoken words into written form and/or using a vision language model or other multi-modal model to create a textual summary of the video content. This conversion may be referred to as “semantic compression.” The conversion allows the system to integrate and process video content alongside textual data. This can increase the likelihood that all relevant information, regardless of its original format, is considered in the generation of the transcript. This capability is particularly advantageous in scenarios where important information is delivered in multimedia formats, which would otherwise be unwieldy or computationally expensive to jointly process in its native modality with all other context data.

Another aspect of the present disclosure is directed to techniques for improving the ability to output audio content of significant length, while retaining semantic consistency and structure. As one example, in some implementations, the computing system can hierarchically generate the transcript by first creating a structured outline from the context data using one or more machine-learned sequence processing models. This outline can include a plurality of sections, each representing a distinct topic or segment of the overall content. For example, in the context of an educational series, the outline might include sections for introduction, key concepts, case studies, and conclusion. Following the creation of the outline, the system can iteratively process each section of the context data to generate a detailed transcript for each respective section. This hierarchical approach increases the likelihood that the final transcript is well-organized and maintains logical coherence throughout the audio content. This is particularly advantageous for complex or lengthy informational material that requires clear segmentation to enhance listener comprehension and/or engagement.

Additional aspects of the present disclosure are directed to techniques for creating audio content that is engaging and natural sounding from the perspective of the human listener. For example, in some implementations, the computing system can generate an initial transcript from the context data using one or more machine-learned sequence processing models. This initial transcript serves as a preliminary version of the audio content. Following this, the system can perform one or more critic-driven rewrite loops to refine and edit the initial transcript, thereby producing an edited transcript. For example, these rewrite loops can include analyzing the initial transcript for any inaccuracies, inconsistencies, or areas that lack clarity or natural flow in the dialogue. The system then makes the necessary adjustments to enhance the quality and accuracy of the content. This iterative process increases the likelihood that the final transcript is not only accurate but also engaging and natural-sounding.

In some implementations, a machine-learned sequence processing model can be used as a computer-implemented critic to improve the quality of audio content through a critic-driven rewrite loop. For example, the sequence processing model can be equipped with specific critique instructions that detail the aspect(s) of the audio content to be critiqued, the desired format of the critique(s), and other relevant guidance to refine the critique process. This model processes the initial transcript according to these instructions and outputs critique(s), potentially in a natural language format. The critique(s) can identify areas for improvement and/or provide specific suggestions for improvement. Based on these critique(s), either the same or a different sequence processing model can then reprocess the initial transcript together with the critique(s) to produce a revised transcript. This revised transcript is specifically rewritten to address the identified critique(s), thereby improving the naturalness, accuracy, and/or relevance of the final audio content. This iterative process of critique and revision increases the likelihood that the generated audio is engaging and natural sounding from the human's perspective, or otherwise meets expectations of quality or accuracy.

As one example, in some implementations, the computing system can enhance the naturalness of the audio content by incorporating an increased amount of disfluencies into the transcript during the critic-driven rewrite loops. Disfluencies, such as slight hesitations, repetitions, or filler words like “um” and “ah,” are common in natural speech and can make synthesized audio content sound more realistic and relatable. For example, when generating a podcast or an interactive dialogue for a virtual assistant, intentionally adding these disfluencies can prevent the audio from sounding too polished or mechanical.

As another example, critic-driven rewrite loops can be performed to enhance the accuracy or “groundedness” of the transcript relative to the source context material. As one example, in some implementations, the computing system can further refine the audio content by processing both the context data and the initial transcript with one or more machine-learned sequence processing models during the critic-driven rewrite loops. This process aims to generate an edited transcript that exhibits increased grounding relative to the context data. For example, if the initial transcript derived from a detailed technical manual lacks certain nuances or context-specific terminologies, the rewrite loops can reintegrate these elements. This can enhance the transcript's fidelity to the source material. This approach increases the likelihood that the final audio content not only sounds natural but also maintains a high level of accuracy and relevance.

As another example, in some implementations, the computing system can enhance the accuracy and clarity of audio content through a re-write loop that identifies and corrects verbalization errors in the ultimate audio content. For example, the system can initially generate audio content from the initial transcript. This initial audio can then be analyzed by one or more machine-learned sequence processing models. These models may be multi-modal models that are adept at detecting verbalization errors such as mispronunciations, grammatical inconsistencies, or unnatural phrasing. As another example, the audio content can be turned back into an additional transcript by a speech-to-text tool. This additional transcript can be compared to the initial transcript to identify any areas of divergence, which would indicate that the audio content does not successfully verbalize the initial transcript (as the additional transcript generated from the audio does not match the intended content). Once any verbalization errors are identified, the system can re-write the initial transcript, removing or replacing the erroneous portions. For example, if the initial audio incorrectly pronounces a technical term, the system can correct these issues in the transcript. This can increase the likelihood that the subsequent audio output is both accurate and correctly verbalized.

As another example, in some implementations, the computing system can personalize the audio content by integrating an audience persona description into the critic-driven re-write loops. This process can include the computing system using the initial transcript along with a detailed description of the audience persona, which could include preferences, specific interests, and/or other information about the intended audience, to tailor the content. For example, the one or more machine-learned sequence processing models can process the initial transcript and the audience persona description to generate an edited transcript that is specifically conditioned on and personalized towards the audience persona. For example, if the audience persona indicates a preference for concise and straightforward explanations, the edited transcript may be adjusted to simplify explanations and avoid jargon. This personalized approach increases the likelihood that the audio content is more engaging and relevant to the listener.

In some implementations, the computing system can generate the audio content from the transcript by processing it through a machine-learned voice model. This model is trained to convert text into natural-sounding speech which mimics human intonation and rhythm. In some implementations, the voice model can be conditioned with data that indicates the particular voice profile or style for one or more of the synthetic speakers contained in the audio content. For instance, the voice model can take a finalized transcript and produce audio that sounds like a human newsreader for a news broadcast or a narrator for an audiobook. In other implementations, standard text-to-speech tools can be used to generate the audio content.

In some implementations, the computing system can additionally generate video content (or other supporting or correlated content) that is either temporally or semantically synchronized with the audio content. This means that the computing system can create visuals that align with the timing and context of the spoken words. For example, the system can output a video that depicts synthetic persons verbalizing the corresponding audio content. The generation of additional supporting or correlated content can enhance the overall multimedia experience. For example, during a news broadcast, as the audio content describes a specific event, corresponding video footage or graphical representations of the event can be displayed. Similarly, in an educational setting, as a concept is explained audibly, relevant diagrams or animations can be shown to aid in comprehension.

In some implementations, the computing system can include a user interface designed to enhance the playback experience of the audio content by providing attribution or citation elements. For example, these elements can be displayed to the user during the audio playback and can be temporally synchronized with the content being played. For example, when a particular scientific study or historical event is mentioned in the audio, the user interface can simultaneously display a citation or attribution linked to that reference, providing immediate access to the source material. This feature is advantageous in settings where verifying the accuracy and source of information is important. It also adds a layer of transparency to the content, allowing users to explore the origins of the information in real-time as they listen.

In some implementations, the technology is capable of generating a diverse range of audio content types to suit various user needs and preferences. For example, the audio content produced can include dialogs, which are conversational pieces between two or more parties, podcasts that cover myriad topics in episodic formats, educational content tailored for learning and development, sports commentary providing real-time or summarized insights into sporting events, news commentary that discusses current events, and/or summaries of recent events or other fresh content. This versatility makes the technology suitable for a wide array of applications, from entertainment and education to sports broadcasting and news reporting.

The systems and methods of the present disclosure provide a number of technical effects and benefits. As one example, the proposed technology enhances the processing efficiency and accuracy of generating audio content from diverse data inputs, including textual and video data. By utilizing advanced machine-learned sequence processing models, the system can transform large volumes of context data into coherent audio outputs. This technical feature addresses the technical challenge of managing and synthesizing vast and varied data types. Another technical benefit relates to the use of critic-driven rewrite loops to refine the generated audio content. These loops allow the system to iteratively improve the audio output by identifying and correcting verbalization errors and/or enhancing the content's alignment with user preferences.

Another significant technical aspect of the proposed technology is its ability to generate audio content that is synchronized with and/or responsive to real-time user interactions. This dynamic interaction capability is facilitated by the system's real-time processing of user inputs, such as questions or commands, to modify the audio content on-the-fly. This feature leverages real-time data handling, such as the use of a RTC framework. In particular, the use of an RTC enables instantaneous streaming and interaction capabilities. RTC facilitates the direct and immediate transmission of audio content over the internet, allowing users to receive and interact with the content with minimal latency. This is particularly advantageous as it enables real-time feedback. Moreover, RTC supports a range of data types, including audio and video, which allows the system to synchronize multiple media streams effectively.

Furthermore, allowing real-time interactive inputs from the user significantly reduces computational expenditure by enabling the system to focus processing resources on specific segments of the transcript that require modification, rather than rewriting the entire transcript. When a user provides an input, such as a question or a command, the system identifies the relevant portion of the ongoing transcript that needs adjustment and processes only that segment. This targeted approach avoids the unnecessary computational load and resource usage that would be included in reprocessing the entire audio content. Additionally, this method enhances efficiency by reducing the latency and processing time, as the system can quickly adapt the content based on real-time feedback without the need to queue changes for the entire document.

As another example technical benefit, the hierarchical processing of context data significantly reduces computational expenditure by breaking down large datasets into manageable chunks before processing. This method is particularly effective due to the computational complexity of attention mechanisms (e.g., which are commonly used in sequence processing models) scales quadratically with the size of the context being processed. By dividing the context data into smaller segments, the system limits the size of the data each processing unit must handle at any one time, thereby reducing the number of computational operations required. This not only speeds up the processing time but also enhances the efficiency of the system, reducing the consumption of computational resources.

Due to the inherent flexibility of computing systems, a variety of device and system configurations can be implemented to facilitate the generation and delivery of audio content. For instance, one example arrangement includes generating audio content on a server, which is then streamed to a user device through a real-time communication (RTC) framework. In this setup, user inputs are captured at the user device and streamed back to the server, allowing the server to update the audio content based on this feedback. Alternatively, configurations where all functionalities are performed directly on the user's device, known as “on-device” configurations, are also feasible. This approach benefits from potentially faster response times and enhanced privacy, as data does not need to be transmitted over a network. Other configurations of functionality are possible as well.

Various example implementations are described herein with respect to the accompanying Figures.

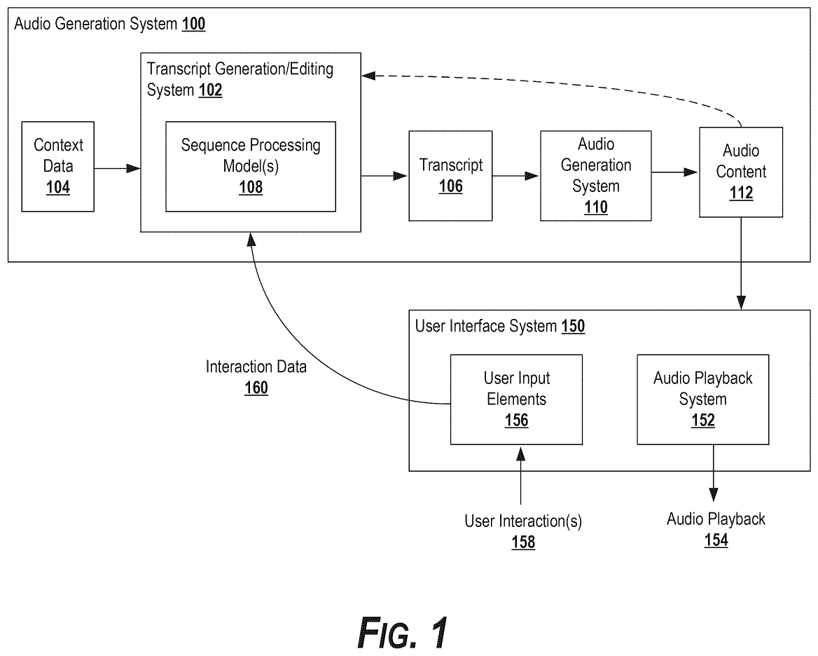

FIG. 1 depicts an example audio generation system 100. The system 100 can automate the generation of audio content from various types of context data through a series of computational steps.

The audio generation system 100 includes a transcript generation/editing system 102, which receives context data 104. The context data 104 can include textual documents, audio files, and/or video content. In some implementations, context data 104 can be converted into a textual format before further processing. The sequence processing model(s) 108 within the transcript generation/editing system 102 are tasked with processing this context data 104 to generate a transcript 106. The transcript 106 may be a structured transcript that includes descriptions of topics contained within the context data 104.

This transcript 106 is then input into the audio generation system 110, which converts the transcript 106 into audio content 112. In some implementations, this conversion can be achieved through a machine-learned voice model that ensures the speech content verbalizes the transcript accurately. Once the audio content 112 is generated, it can be streamed to users via a real-time communication framework as part of the playback process. In some implementations, the audio generation system 100 is implemented by a server system comprising one or more server computing devices.

Additionally, FIG. 1 illustrates a user interface system 150 that enables user interaction with the audio content 112. The user interface system 150 can include an audio playback system 152 that can facilitate playback (e.g., via one or more speakers) of the audio content 112 to a user.

The interface system 150 can also include user input elements 156, which can receive user interactions 158 from the user. The user input elements 156 can transform the user interactions 158 into interaction data 160 which is provided back to the audio generation system (e.g., specifically to the transcript editing system 102). The transcript editing system 102 can use the interaction data 160 to revise, edit, or otherwise influence the content generation process. For example, the interaction data 160 may include user commands or feedback that the sequence processing model(s) 108 use to adjust the transcript 106 in real-time.

In some implementations, the audio playback system 152 further manages the playback of the audio content 112 so that it is controlled relative to or based on any user interactions 158, such as questions or commands that might alter the flow of the content. Furthermore, the user interface system 150 can display attribution or citation elements that are synchronized with the audio playback, providing users with additional information about the sources of the content they are listening to.

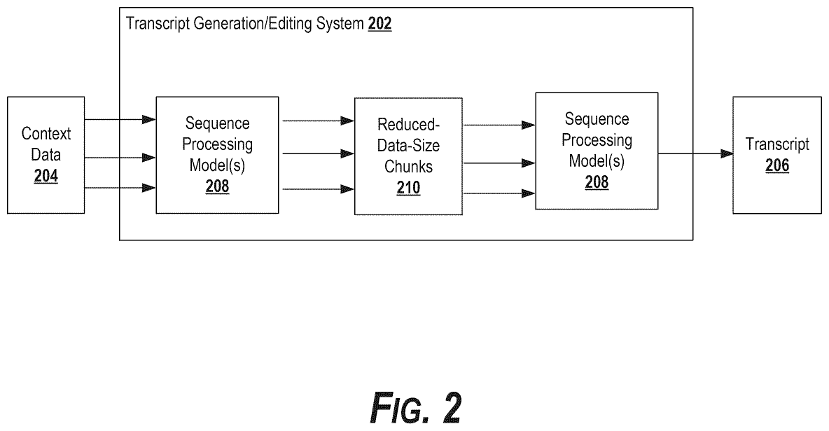

FIG. 2 illustrates an example workflow within an example transcript generation/editing system 202 of the audio generation system. This diagram demonstrates the step-by-step process for transforming context data into a structured transcript that can be converted into audio content.

The process starts with the context data 204, which can include various forms of data such as text, audio, or video. This data is input into the sequence processing model(s) 208, which are designed to analyze and process the data. Specifically, the system 202 can first segment the context data 204 into smaller, more manageable chunks. These smaller chunks can then be processed by the sequence processing model(s) 208 to generate reduced-data-size chunks 210. This segmentation and data size reduction simplifies the complexity of the data, making it easier for further processing.

Following the creation of reduced-data-size chunks 210, these chunks are again processed by the sequence processing model(s) 208. This subsequent processing can include a deeper analysis and synthesis of the data to construct a coherent and comprehensive transcript 206. This transcript is then ready to be fed into an audio generation system where it will be converted into speech content.

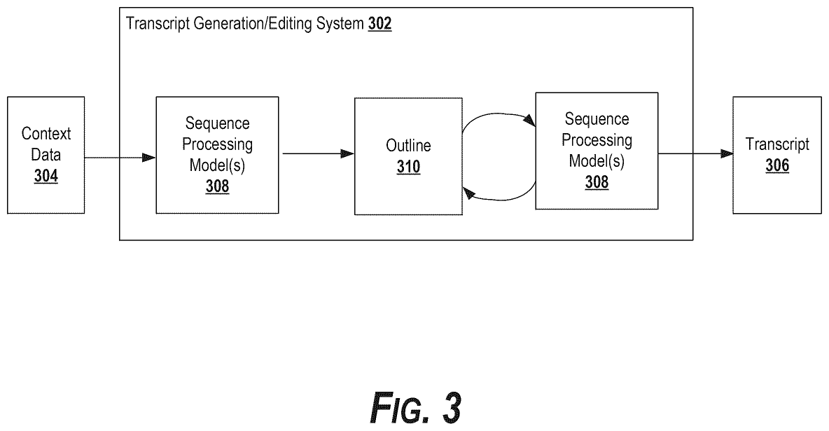

FIG. 3 illustrates a schematic representation of an example workflow within a transcript generation/editing system 302. This system is designed to process context data and generate a structured transcript suitable for conversion into audio content.

The process begins with context data 304, which can include various types of information such as textual documents, audio files, or video content. The context data 304 is fed into the sequence processing model(s) 308, which are responsible for analyzing the context data and extracting relevant information. These models can be machine-learned models trained to process large datasets and identify key elements necessary for generating a transcript.

Following the initial processing, the output of the model(s) 308 can include an outline 310 or other hierarchical structure for generation of the transcript. The outline 310 can organize the extracted information and/or transcript into a structured format, dividing the content into sections or topics. This structured outline 310 serves as a framework for the subsequent detailed transcript generation.

The outline 310 is then fed back into the sequence processing model(s) 308. In this stage, the models process each section of the outline iteratively, ensuring that the detailed content for each section is accurately and comprehensively developed. This iterative processing helps in maintaining the logical flow and coherence of the final transcript.

The final output from the sequence processing model(s) 308 is the transcript 306. The transcript 306 is formatted according to the structured outline. This transcript is then ready to be converted into speech content in further processing steps not shown in FIG. 3.

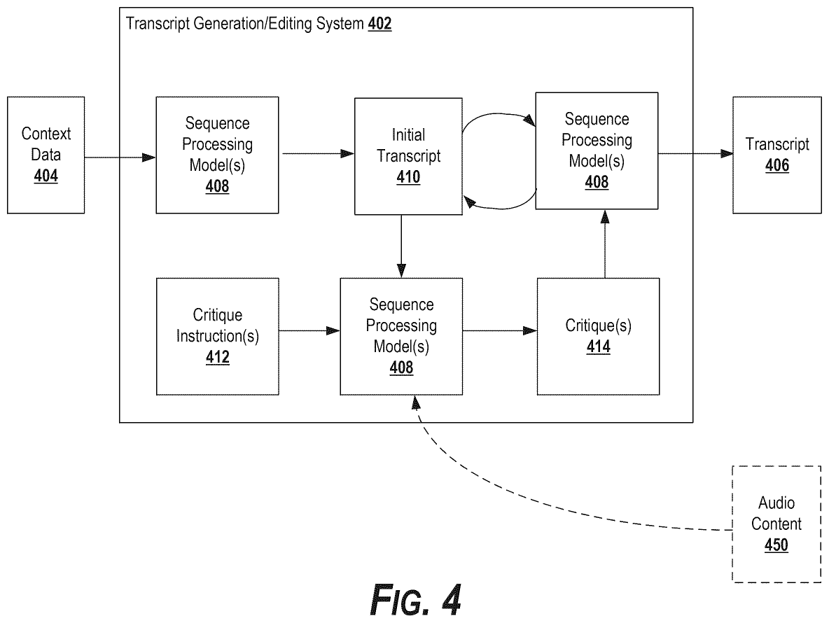

FIG. 4 illustrates a graphical diagram of an example workflow within a transcript generation/editing system 402, illustrating the integration of critic-driven feedback loops for refining transcripts.

The process starts with context data 404, which can include a variety of information sources such as text, audio, and video data. This context data 404 is input into the sequence processing model(s) 408, which analyze the data to extract relevant information and generate an initial transcript 410. The initial transcript 410 represents a preliminary version of the textual content derived from the context data 404.

Once the initial transcript 410 is generated, it is subjected to a critique process. Critique instruction(s) 412 provide guidelines or parameters that define the aspects of the transcript to be reviewed and the nature of the feedback desired. These instructions can specify areas to focus on, such as accuracy, clarity, style, or adherence to specific informational priorities.

The sequence processing model(s) 408 then use the critique instruction(s) 412 to assess the initial transcript 410 and generate critique(s) 414. The critique(s) 414 can include feedback that identifies potential improvements or corrections needed in the initial transcript 410. This feedback can include suggestions for rewording, adding missing information, correcting errors, or enhancing the flow and naturalness of the text.

Following the generation of the critique(s) 414, the sequence processing model(s) 408 reprocess the initial transcript 410 in light of the critique(s) 414. This iterative loop allows for the refinement of the transcript, aiming to address the issues highlighted in the critique(s) 414 and improve the overall quality of the transcript. The refined transcript is then output as transcript 406, which is a more polished and/or accurate representation of the context data 404.

In some implementations, audio content 450 generated from the initial transcript 410 can be used by the model(s) 408 when generating the critique(s) 414. For example, this may enable the model(s) 408 (when acting as critic(s)), to have insight into the actual final audio product. For example, this may enable the detection of verbalization errors.

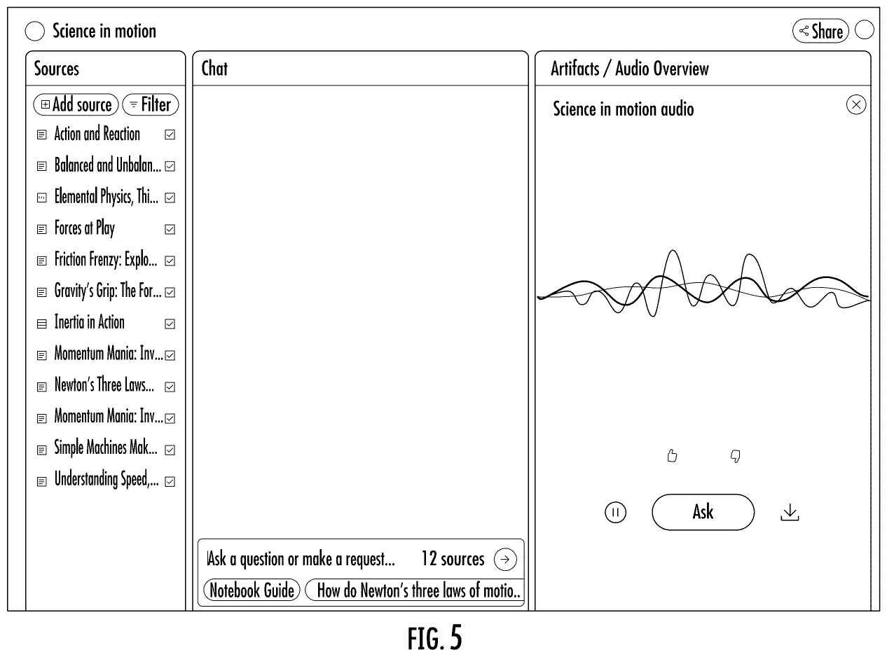

FIG. 5 illustrates a user interface designed to interact with the audio generation system, illustrating how users can engage with the system to influence the audio content being generated. This interface allows for real-time interaction and feedback, which facilitates customizing and enhancing the user experience as described herein.

The example interface features a multi-panel layout. On the left panel, there is a list of “Sources” which include various topics or documents that users can select to generate audio content. This part of the interface allows users to choose specific content they are interested in, which may correspond to obtaining context data. The right panel, labeled “Artifacts/Audio Overview,” displays a visual representation of the audio waveform, indicating that the audio content is currently being played or is available for playback.

Below the waveform, there are control buttons such as play, pause, and volume adjustment, alongside an “Ask” button. By selecting the “Ask” button, the user can input queries or commands to the system. Thus, users can input additional conditioning interactions, such as questions or commands, which the system processes to adjust the ongoing audio content dynamically.

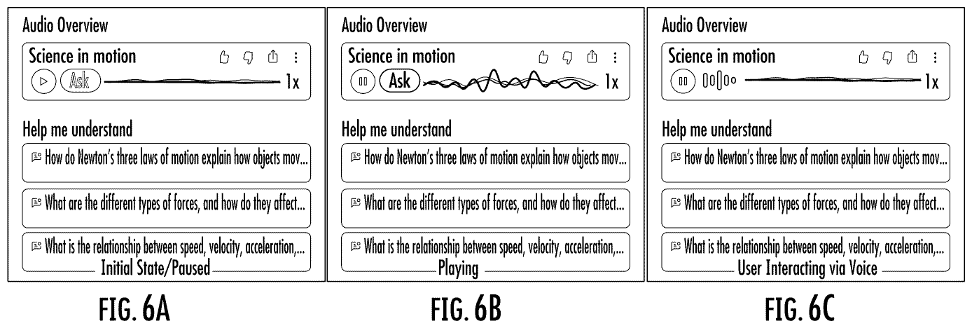

FIGS. 6A-C depict various states of a user interface that facilitates interaction with an audio content generation system. FIG. 6A shows an initial state or paused state of the audio playback interface. In this visualization, the audio content titled “Science in Motion” is not actively playing. This state allows users to initiate playback at their convenience. The interface also includes a help section with questions that users might ask related to the audio content, illustrating integration with an interactive query system that enhances user understanding and engagement.

FIG. 6B illustrates the playing state of the same audio content. In this state, the interface shows a pause button, as the audio is currently active. The waveform of the audio is visibly animated, providing a visual representation of the audio dynamics as it plays. The interface now includes an “Ask” button which the user can actively select. By selecting the “Ask” button, the user can input queries or commands to the system. Thus, users can input additional conditioning interactions, such as questions or commands, which the system processes to adjust the ongoing audio content dynamically.

FIG. 6C represents a user interaction state via voice, where the interface shows that the system is actively listening to a user's voice input, as indicated by the microphone icon and sound levels. This user interface may provide this state when receiving real-time interaction data from the user. These user inputs can dynamically influence the playback or content of the audio, such as pausing the audio to process the spoken queries and/or adjusting the audio content based on the user's interactions.

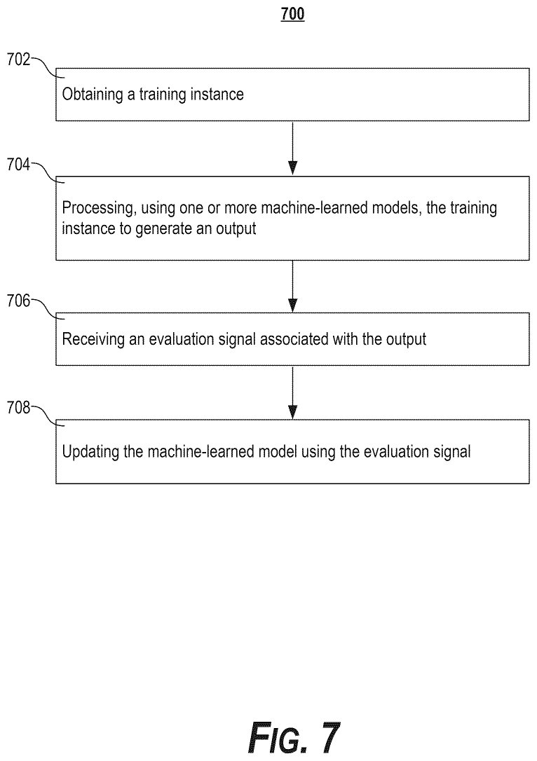

FIG. 7 depicts a flowchart of a method 700 for training one or more machine-learned models according to aspects of the present disclosure. For instance, an example machine-learned model can include a sequence processing model.

One or more portion(s) of example method 700 can be implemented by a computing system that includes one or more computing devices such as, for example, computing systems described with reference to the other figures. Each respective portion of example method 700 can be performed by any (or any combination) of one or more computing devices. Moreover, one or more portion(s) of example method 700 can be implemented on the hardware components of the device(s) described herein, for example, to train one or more systems or models. FIG. 7 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 7 is described with reference to elements/terms described with respect to other systems and figures for exemplary illustrated purposes and is not meant to be limiting. One or more portions of example method 700 can be performed additionally, or alternatively, by other systems.

At 702, example method 700 can include obtaining a training instance. A set of training data can include a plurality of training instances divided between multiple datasets (e.g., a training dataset, a validation dataset, or testing dataset). A training instance can be labeled or unlabeled. Although referred to in example method 700 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 704, example method 700 can include processing, using one or more machine-learned models, the training instance to generate an output. The output can be directly obtained from the one or more machine-learned models or can be a downstream result of a chain of processing operations that includes an output of the one or more machine-learned models.

At 706, example method 700 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi-or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 708, example method 700 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 700 can include implementing a number of generalization techniques (e.g., weight decays, dropouts, etc.) to improve the generalization capability of the models being trained.

In some implementations, example method 700 can be implemented for training a machine-learned model from an initialized state to a fully trained state (e.g., when the model exhibits a desired performance profile, such as based on accuracy, precision, recall, etc.).

In some implementations, example method 700 can be implemented for particular stages of a training procedure. For instance, in some implementations, example method 700 can be implemented for pre-training a machine-learned model. Pre-training can include, for instance, large-scale training over potentially noisy data to achieve a broad base of performance levels across a variety of tasks/data types.

In some implementations, example method 700 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). In some implementations, example method 700 uses adapter modules. Adapters can be small trainable layers that are inserted between pre-existing layers of a pre-trained model. During the fine-tuning process, the original parameters of the pre-trained model are typically frozen, and only the parameters of the adapters are updated.

In some implementations, example method 700 can be implemented to execute parameter-efficient fine-tuning methods, such as Layerwise Optimization of Residuals (LoRA). LoRA can refine pre-trained models with minimal adjustments to the original parameters. This can be achieved by introducing trainable low-rank matrices that modify the behavior of the pre-trained weights without directly altering them. In some implementations, during fine-tuning, only these auxiliary matrices are updated, which significantly reduces the number of parameters that are trained.

An example fine-tuning approach includes reinforcement learning. Reinforcement learning can be based on user feedback on model performance during use.

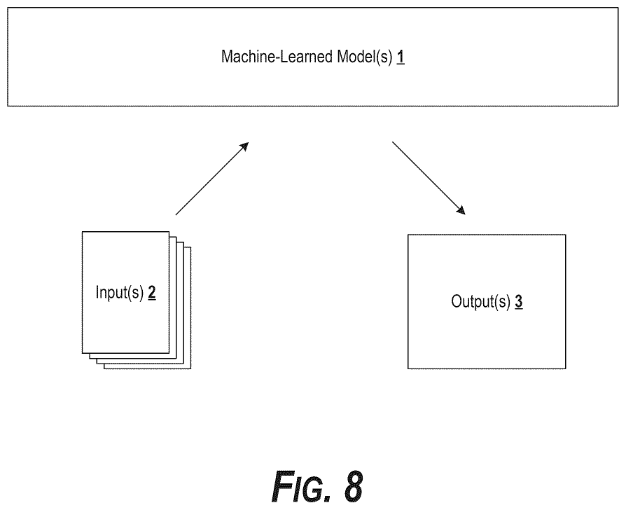

FIG. 8 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Machine-learned model(s) 1 can be or include, or otherwise be representative of any one or more of the machine-learned models described above with respect to the preceding figures. For example, machine-learned model(s) 1 can be or include, or otherwise be representative of any one or more of the models described herein, etc. Although various features, variations, and implementations described below are described with respect to machine-learned model(s) 1, it is to be understood that such features, variations, and implementations are to be understood as described with respect to each machine-learned component described herein.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include multiple different models or multiple different model portions configured to operate on data from input(s) 2.

Machine-learned model(s) 1 can include an ensemble of different models that can cooperatively interact to process data from input(s) 2. For example, a model ensemble can include multiple models that have different attributes (e.g., different architectures, trained with different recipes, etc.). The ensemble can output an overall output based on the individual outputs of the constituent models. In this manner, for instance, the diverse constituent models can work together to provide system-level robustness by effectively aggregating over individual strengths and weaknesses of any given model. The respective individual outputs can be combined in a weighted combination, using a voting or routing mechanism, or a learned output layer (e.g., one or more feedforward or fully-connected layers).

Machine-learned model(s) 1 can employ a mixture-of-experts structure. See, e.g., Zhou et al., Mixture-of-Experts with Expert Choice Routing, ARXIV:2202.09368v2 (Oct. 14, 2022). For example, different portions of a model can learn (explicitly or implicitly) different expertise areas, with pathways through the model being selected by a learned routing mechanism that engages the appropriate expert for a given input (e.g., a given portion of an input, such as on a per-token basis). For example, a feedforward network can be sparsely activated for a given portion of an input based on an output of a routing mechanism that processes the portion of the input. In this manner, for instance, the group of activated weights can form an “expert” that is selected by the router. On each forward pass, only a subset of the total model weights may be engaged, thereby decreasing a quantity of operations performed for processing a given input compared to a densely activated model. In this manner, for instance, the expressive and interpretive power of a high-parameter-count model can be achieved with more compute-efficient forward passes.

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

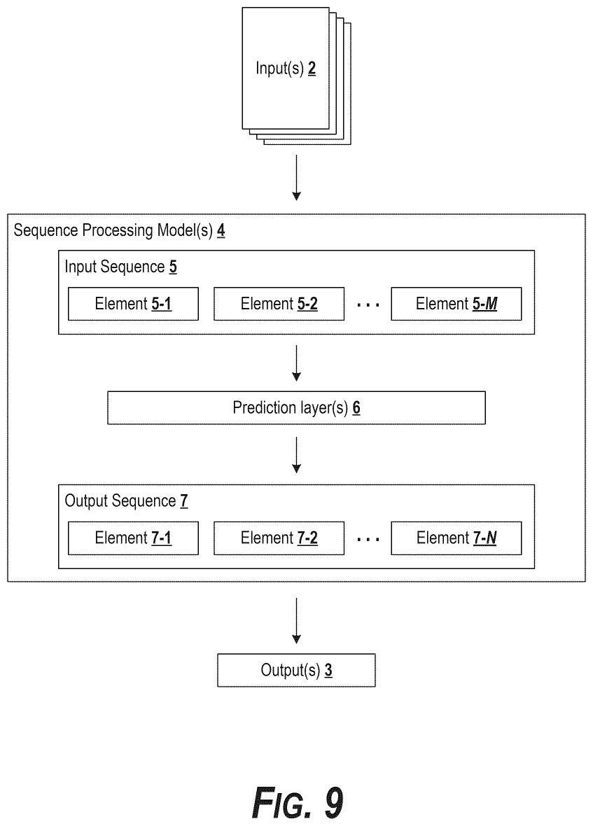

FIG. 9 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models are referred to as language models and can leverage language-based understandings across one or multiple modalities of input information. Sequence processing model(s) 4 can include relatively large models (e.g., more parameters, computationally expensive, etc.), which may be referred to as “Large Language Models” or LLMs. Sequence processing model(s) 4 can include relatively small models (e.g., fewer parameters, computationally lightweight, etc.), which may be referred to as “Small Language Models” or SLMs. Example language models include, for instance, models described in Gemma: Open Models Based on Gemini Research and Technology, GOOGLE, https://arxiv.org/abs/2403.08295; Gemma 2: Improving Open Language Models at a Practical Size, GOOGLE, https://arxiv.org/abs/2408.00118.

Sequence processing model(s) 4 can process one or multiple types of data simultaneously. Variations of language models that can perform joint vision and language tasks may be referred to as “Vision-Language Models,” or VLMs. Example VLMs include models described in PaliGemma: A versatile 3B VLM for transfer, GOOGLE, https://arxiv.org/abs/2407.07726; PaliGemma 2: A Family of Versatile VLMs for Transfer, GOOGLE, https://arxiv.org/abs/2412.03555; Flamingo: a Visual Language Model for Few-Shot Learning, GOOGLE, https://arxiv.org/abs/2204.14198; PaLI: A Jointly-Scaled Multilingual Language-Image Model, GOOGLE, https://arxiv.org/abs/2209.06794.

Sequence processing model(s) 4 can be multimodal. Example multimodal sequence processing models include, for instance, models described in Gemini: A Family of Highly Capable Multimodal Models, GOOGLE, https://arxiv.org/abs/2312.11805; Gemini 1.5: Unlocking multimodal understanding across millions of tokens of context, GOOGLE, https://arxiv.org/abs/2403.05530.

Other example sequence processing models can operate to generate outputs or receive inputs in specific domains, such as image domains, see, e.g., Dosovitskiy et al., An Image is Worth 16×16 Words: Transformers for Image Recognition at Scale, ARXIV:2010.11929v2 (Jun. 3, 2021), audio domains, see, e.g., Agostinelli et al., MusicLM: Generating Music From Text, ARXIV:2301.11325v1 (Jan. 26, 2023), biochemical domains, see, e.g., Jumper et al., Highly accurate protein structure prediction with AlphaFold, 596 Nature 583 (Aug. 26, 2021), by way of example.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . 5-M can represent tokens obtained using a tokenizer. For instance, a tokenizer can process a given portion of an input source and output a series of tokens (e.g., corresponding to input elements 5-1, 5-2, . . . 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (October 31-November 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . 5-M depicted in FIG. 9 can be the tokens or can be the embedded representations thereof.

Prediction layer(s) 6 can predict one or more output elements 7-1, 7-2, . . . 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ___.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

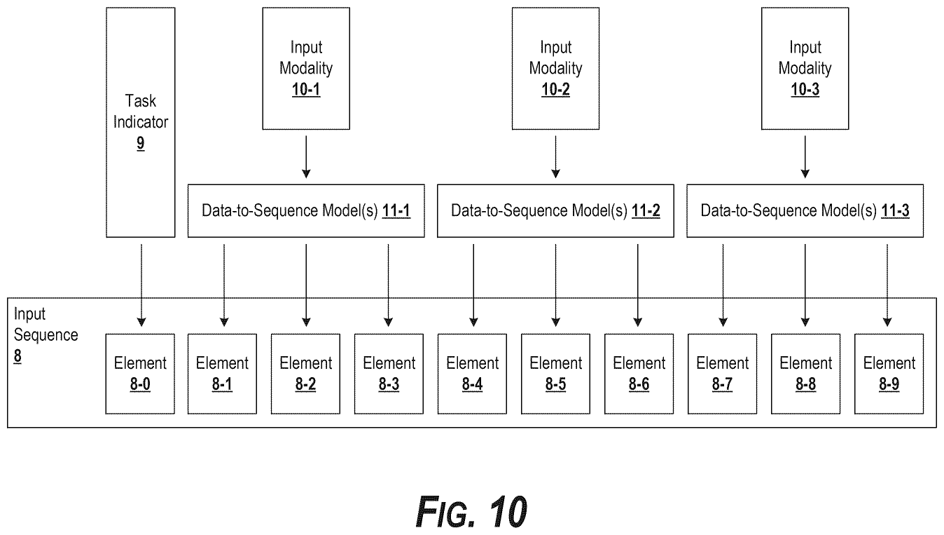

FIG. 10 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0,. 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary data type data-to-sequence model can subdivide an input of that arbitrary data type and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

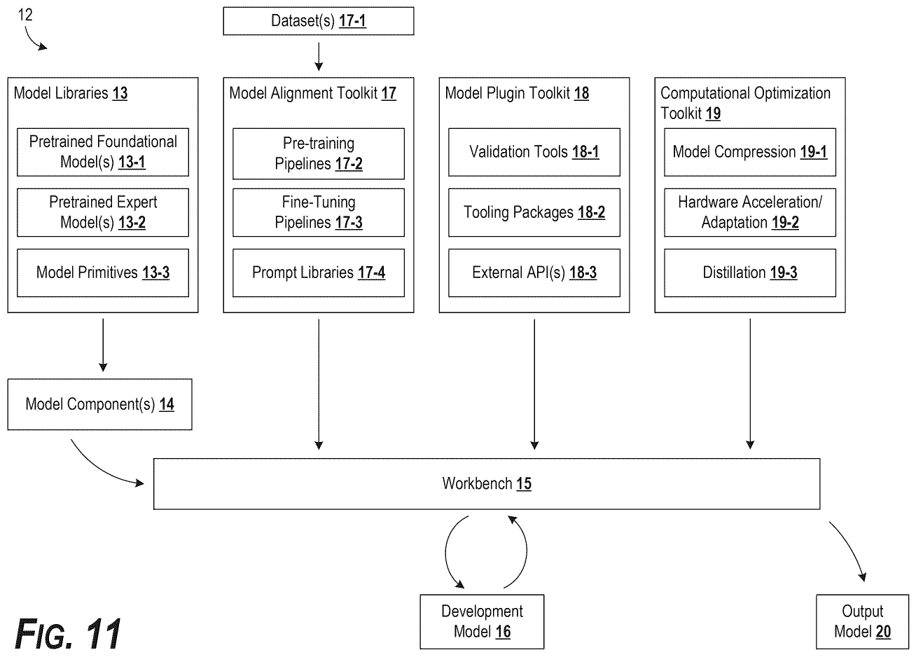

FIG. 11 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired. Model primitives 13-3 can include a library of pre-trained adapters or LoRA modules that can adapt a baseline foundational model to align its outputs with a desired performance profile, augment model capabilities (e.g., to adapt to a different input modality, etc.), and the like.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing the accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output an input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 700 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instructions that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

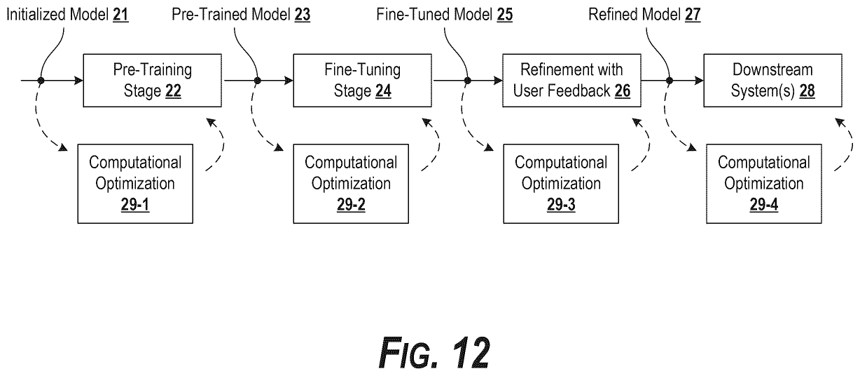

FIG. 12 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 12 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 12 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . 29-4 can all be the same, all be different, or include at least some different optimization techniques.

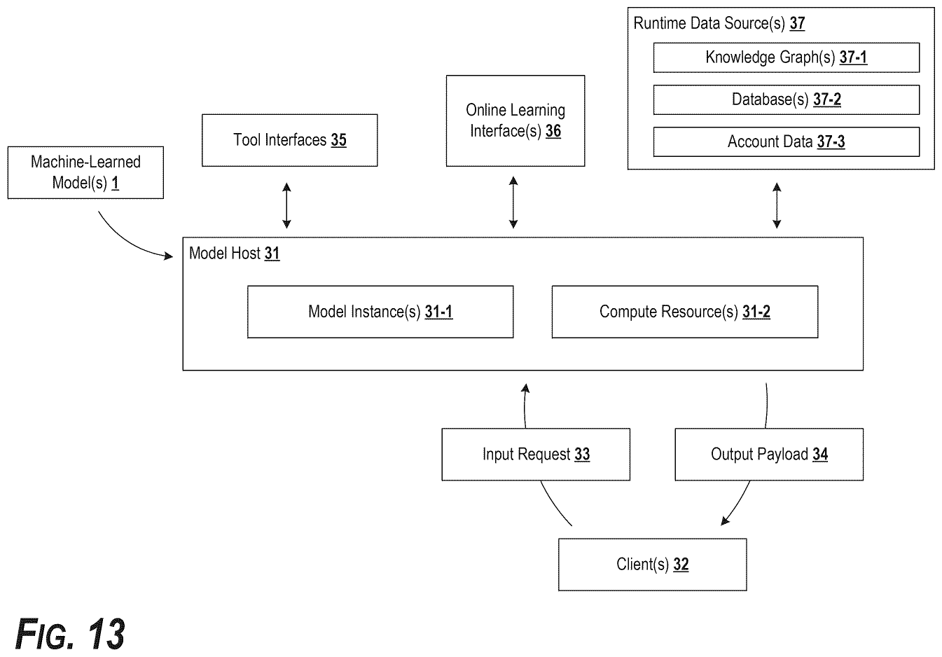

FIG. 13 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on the same device or system as client(s) 32. Model host 31 can be a machine-learning service that runs on-device to provide machine-learning functionality to one or multiple applications operating on a client device, which can include an application implementing client(s) 32. Model host 31 can be a part of the same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can access a library of pre-trained adapters or LoRA modules that can adapt a baseline model to align its outputs with a desired performance profile, augment model capabilities (e.g., to adapt to a different input modality, etc.), and the like. For instance, model host 31 can receive an input request to load a customized model, and model host 31 can retrieve one or more components to adapt a baseline model to the custom profile. Model host 31 can determine that a particular functionality is needed for a particular task (e.g., based on an output of a model that preprocesses an input) and retrieve a pre-trained component accordingly.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction-following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

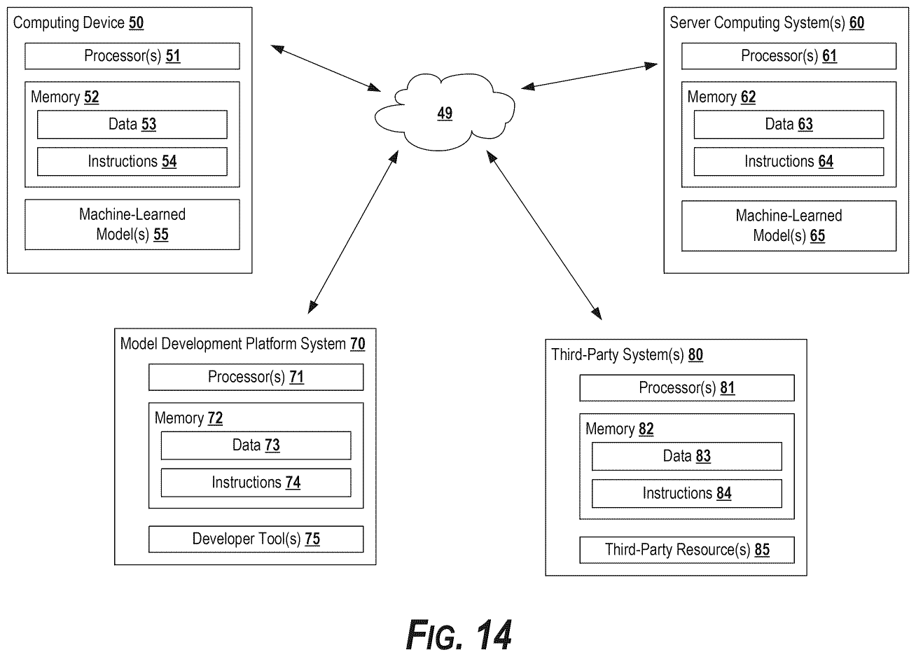

FIG. 14 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 14 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 14 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

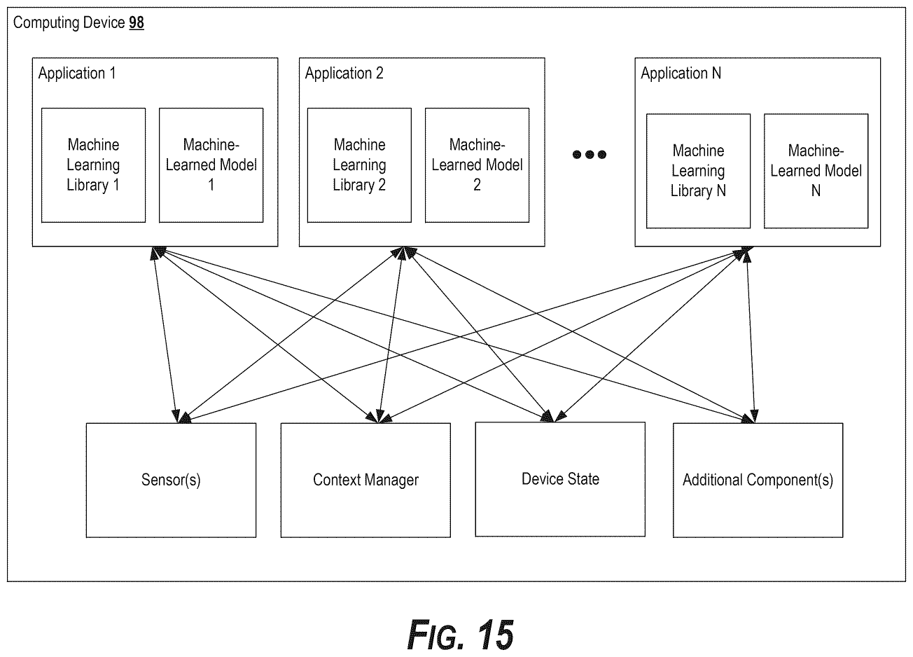

FIG. 15 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 15, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

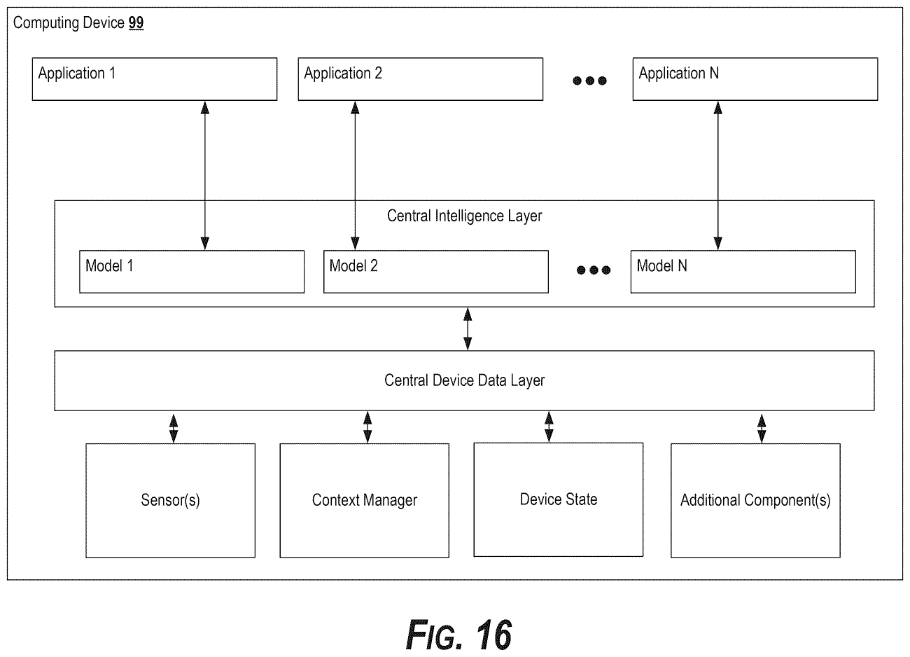

FIG. 16 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 16, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 16, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method for automatic generation of audio content, the method comprising:
obtaining, by a computing system comprising one or more computing devices, a corpus of context data;
processing, by the computing system, the context data with a one or more machine-learned sequence processing models to generate, as output of the one or more machine-learned sequence processing models, a transcript for audio content, wherein the transcript comprises description of one or more topics contained within the context data;
generating, by the computing system, audio content from the transcript, wherein the audio content comprises speech content that verbalizes the transcript; and
providing, by the computing system, the audio content for playback.

2. The computer-implemented method of claim 1, further comprising:
receiving, by the computing system, interaction data, wherein the interaction data comprises an additional conditioning input;
processing, by the computing system, the additional conditioning input and at least a portion of the transcript with the one or more machine-learned sequence processing models to generate, as output of the one or more machine-learned sequence processing models, an updated transcript;
generating, by the computing system, updated audio content from the updated transcript; and
providing, by the computing system, the updated audio content for playback.

3. The computer-implemented method of claim 2, wherein receiving the interaction data comprises receiving the interaction data during playback of the audio content, and wherein the method comprises pausing playback of the audio content during generation of the updated audio content.

4. The computer-implemented method of claim 2, wherein the portion of the transcript comprises a remaining portion of the transcript that temporally follows an interaction time associated with the injection data.

5. The computer-implemented method of claim 2, wherein the additional conditioning input comprises: an interjection, a clarification request, an on-topic question, a focus steering input, an exclusion steering input, a target audience steering input, a host persona steering input, or a tone or format steering input.

6. The computer-implemented method of claim 2, wherein the interaction data comprises user speech data captured by a microphone.

7. The computer-implemented method of claim 1, wherein providing the audio content for playback comprises streaming the audio content via a real-time communication (RTC) framework.

8. The computer-implemented method of claim 1, wherein processing, by the computing system, the context data with the one or more machine-learned sequence processing models to generate the transcript comprises:
dividing, by the computing system, the context data into a plurality of chunks;
respectively processing, by the computing system, the plurality of chunks individually with the one or more machine-learned sequence processing models to respectively generate a plurality of reduced-data-size content chunks; and
processing, by the computing system, the plurality of reduced-data-size content chunks with the one or more machine-learned sequence processing models to generate the transcript.

9. The computer-implemented method of claim 1, wherein processing, by the computing system, the context data with the one or more machine-learned sequence processing models to generate the transcript comprises:
prior to processing the context data to generate the transcript, transforming, by the computing system, at least one video contained in the context data into a textual format.

10. The computer-implemented method of claim 1, wherein processing, by the computing system, the context data with the one or more machine-learned sequence processing models to generate the transcript comprises hierarchically generating the transcript.

11. The computer-implemented method of claim 10, wherein hierarchically generating the transcript comprises:
processing, by the computing system, the context data with the one or more machine-learned sequence processing models to generate, as output of the one or more machine-learned sequence processing models, an outline for the audio content, wherein the outline comprises a plurality of sections; and
iteratively processing, by the computing system, the context data with the one or more machine-learned sequence processing models to iteratively generate, as output of the one or more machine-learned sequence processing models, a portion of the transcript for each of the plurality of sections.

12. The computer-implemented method of claim 1, wherein processing, by the computing system, the context data with the one or more machine-learned sequence processing models to generate the transcript comprises:
processing, by the computing system, the context data with the one or more machine-learned sequence processing models to generate, as output of the one or more machine-learned sequence processing models, an initial transcript for the audio content; and
performing, by the computing system, one or more critic-driven re-write loops to edit the initial transcript to generate an edited transcript.

13. The computer-implemented method of claim 12, wherein performing, by the computing system, the one or more critic-driven re-write loops comprises rewriting, by the computing system, the initial transcript to include an increased amount of disfluencies.

14. The computer-implemented method of claim 12, wherein performing, by the computing system, the one or more critic-driven re-write loops comprises processing, by the computing system, the context data and the initial transcript with the one or more machine-learned sequence processing models to generate, as output of the one or more machine-learned sequence processing models, the edited transcript, wherein the edited transcript exhibits increased grounding relative to the context data.

15. The computer-implemented method of claim 12, wherein performing, by the computing system, the one or more critic-driven re-write loops comprises:
generating, by the computing system, initial audio content from the initial transcript; and
processing, by the computing system, the initial audio content with the one or more machine-learned sequence processing models to identify one or more verbalization errors; and
re-writing, by the computing system, the initial transcript to remove or replace portions of the transcript corresponding to the one or more verbalization errors.

16. The computer-implemented method of claim 12, wherein performing, by the computing system, the one or more critic-driven re-write loops comprises processing, by the computing system, the initial transcript and an audience persona description with the one or more machine-learned sequence processing models to generate, as output of the one or more machine-learned sequence processing models, the edited transcript, wherein the edited transcript is conditioned on and personalized toward an audience persona contained in the audience persona description.

17. The computer-implemented method of claim 1 wherein generating, by the computing system, the audio content from the transcript comprises processing, by the computing system, the transcript with a machine-learned voice model to generate the audio content as an output of the machine-learned voice model.

18. The computer-implemented method of claim 1, further comprising generating, by the computing system, video content that is temporally or semantically synchronized with the audio content.

19. The computer-implemented method of claim 1, further comprising providing, by the computing system, a user interface for display to a user during playback of the audio content, wherein the user interface comprises one or more attribution or citation elements that provide attribution or citation information relative to the context data during playback of the audio content, wherein the one or more attribution or citation elements are temporally synchronized with the playback of the audio content.

20. A computing system comprising one or more processors and one or more non-transitory computer-readable media that store instructions that, when executed by the one or more processors, cause the computing system to perform operations, the operations comprising:
obtaining, by the computing system, a corpus of context data;
processing, by the computing system, the context data with a one or more machine-learned sequence processing models to generate, as output of the one or more machine-learned sequence processing models, a transcript for audio content, wherein the transcript comprises description of one or more topics contained within the context data;
generating, by the computing system, audio content from the transcript, wherein the audio content comprises speech content that verbalizes the transcript; and
providing, by the computing system, the audio content for playback.
